(19) United States
(12) Patent Application Publication
(10) Pub. No.: US 2005/0164065 A1
(43) Pub. Date: Jul. 28, 2005

(54) Fuel cell system and fuel supply unit used therein

(76) Inventors: Seong-Jin An, Suwon-si (KR); Ho-Jin Kweon, Suwon-si (KR); Hyoung-Juhn Kim, Suwon-si (KR); Ju-Yong Kim, Suwon-si (KR); Yeong-Chan Eun, Suwon-si (KR); Sung-Yong Cho, Suwon-si (KR); Jin-Kyoung Moon, Suwon-si (KR); Dong-Hun Lee, Suwon-si (KR)

Correspondence Address: CHRISTIE, PARKER & HALE, LLP, PO BOX 7068, PASADENA, CA, 91109-7068, US

(21) Appl. No.: 11/043,776

(22) Filed: Jan. 25, 2005

(30) Foreign Application Priority Data
Jan. 26, 2004 (KR) 10-2004-0004664

(51) Int. Cl. H01M 8/04; H01M 8/06; B65D 6/00

(52) U.S. Cl. 429/34; 429/19; 220/4.12

(57) ABSTRACT

A fuel cell system includes at least one electricity generator which generates electric energy through electrochemical reaction between hydrogen and oxygen, a fuel supply unit which supplies fuel containing hydrogen to the electricity generator, and an oxygen source which supplies oxygen to the at least one electricity generator. The fuel supply unit comprises an outer tank defining an inner space, and an inner fuel storage tank with deformable walls which is provided in the inner space of the outer tank to store fuel. Fuel is discharged from the inner fuel storage tank by the deformation of the inner fuel storage tank by applying a compressive force to the inner space of the outer tank through the use of a biasing mechanism.

### CROSS REFERENCE TO RELATED APPLICATION

This application claims priority to and the benefit of Korean Patent Application No. 10-2004-0004664 filed on Jan. 26, 2004 in the Korean Intellectual Property Office, the entire content of which is incorporated by reference as if fully set forth herein.

### FIELD OF THE INVENTION

The present invention relates to a fuel cell system, and more particularly, to a fuel cell system having a fuel supply unit with an improved structure.

### BACKGROUND OF THE INVENTION

As is well known, a fuel cell is an electric-power generating system in which energy from the chemical reaction between oxygen and the hydrogen contained in a hydrocarbon material such as methanol, ethanol, and natural gas is directly converted into electric energy.

Fuel cells are generally classified as phosphate fuel cells, molten carbonate fuel cells, solid oxide fuel cells, polymer electrolyte fuel cells, alkali fuel cells, or other types of fuel cells. These different types of fuel cells generally work using the same basic principles, but are different from each other in the kinds of fuel used, the operating temperatures, the catalysts used, and the electrolytes used.

A polymer electrolyte membrane fuel cell (PEMFC) has been developed recently with excellent output characteristics, low operating temperature, and fast starting and response characteristics compared to other fuel cells. The PEMFC can be widely applied to mobile power sources used for vehicles, distributed power sources used for homes and buildings, small power sources used for electronic appliances, and the like.

The PEMFC system basically comprises a stack, a reformer, a fuel tank, and a fuel pump. The fuel pump supplies fuel from the fuel tank to the reformer. The reformer reforms the fuel to generate hydrogen gas which is supplied to the stack along with air as the oxygen source. At the stack, the hydrogen reacts with oxygen to produce water and electricity.

Because the fuel is supplied to the reformer under pressure, as is the air supplied to the stack, a portion of the electric power generated by the stack is generally consumed in supplying fuel and air to the system. Such energy consumed by the system is referred to as parasitic power. Such parasitic power can reduce the energy efficiency of the entire system, especially where an additional pump is required for supplying fuel to the reformer.

An additional problem with a conventional fuel cell system employing an extra pump is that extra space is required for the additional pump. This makes it difficult to reduce the size of the entire system.

### SUMMARY OF THE INVENTION

According to one embodiment of the present invention a fuel cell system is provided having a fuel supply unit which can enhance the system efficiency by reducing the parasitic power while also reducing the size of the entire system.

According to an embodiment of the present invention, a fuel supply unit for a fuel cell system is provided comprising an outer tank defining an inner space and an inner fuel storage tank with deformable walls provided in the inner space of the outer tank. The fuel is discharged by compressing the deformable walls of the inner fuel storage tank with a compressive force applied by a biasing mechanism. In one embodiment, the outer tank is substantially cylindrical in shape.

In another embodiment, the inner fuel storage tank includes flexible outer walls. For example, the inner fuel storage tank may include a bellows-shaped wall portion.

In one embodiment of the invention, the biasing mechanism comprises a source of compressed gas connected to the outer tank. By injecting compressed gas into the inner space of the outer tank, pressure is imparted to the inner fuel storage tank to compress it so that fuel may be produced to the reformer or the stack depending on the type of fuel cell system used.

According to another embodiment of the present invention, the biasing mechanism of the fuel supply unit comprises an elastic member which is provided in the inner space of the outer tank and connected to the inner fuel storage tank.

According to yet another embodiment of the present invention, a fuel cell system is provided comprising at least one electrical generator which generates electric energy through an electrochemical reaction between hydrogen and oxygen, a fuel supply unit which supplies fuel containing hydrogen to the electricity generator, and an oxygen source which supplies oxygen to the at least one electricity generator.

In such an embodiment, the fuel supply unit may comprise a cylindrical outer tank defining a cylindrical inner space, and an inner fuel storage tank with deformable walls for storing fuel provided in the inner space of the cylindrical outer tank as described in further detail above. The fuel is discharged by applying a compressive force to the inner space of the outer tank using a biasing mechanism connected to the cylindrical outer tank, thereby compressing the inner fuel storage tank.

The fuel cell system according to the present invention may comprise a stack formed by stacking a plurality of the electricity generators.

In another embodiment of the fuel cell system of the present invention, the outer tank includes an injection port through which compressed gas from the source of compressed gas is injected into the inner space of the outer tank, and a discharge port through which the fuel is produced to either a reformer or the stack.

A fuel cell system according to the present invention may also comprise a discharge port with a threaded coupling for easily connecting or disconnecting the fuel supply unit to the reformer or the stack.

A fuel cell system according to the present invention may also include a cylindrical outer tank that comprises static pressure valves for selectively opening and closing the injection port and the discharge port.

In one embodiment of a fuel cell system according to the present invention, the biasing mechanism may comprise an elastic member provided in the inner space of a cylindrical outer tank and connected to the inner fuel storage tank. An example of such an elastic member is a compression spring.

In the fuel cell system according to the present invention, the oxygen source may comprise an air pump which draws air from the atmosphere to supply oxygen to the at least one electricity generator.

The fuel cell system according to the present invention may employ a direct methanol fuel cell (DMFC) scheme.

According to another aspect of the present invention, a fuel cell system is provided comprising: at least one electricity generator which generates electric energy through the electrochemical reaction between hydrogen and oxygen; a reformer which generates hydrogen gas from fuel containing hydrogen and supplies the hydrogen gas to the at least one electricity generator; a fuel supply unit as described above for supplying fuel to the reformer; and an oxygen source which supplies oxygen to the electricity generator.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating the structure of a fuel cell system according to one embodiment of the present invention;

FIG. 2 is an exploded perspective view illustrating the structure of a fuel cell stack such as is shown in FIG. 1;

FIG. 3 is a partially cutaway perspective view illustrating the fuel supply unit of FIG. 1;

FIG. 4 is a cross-sectional view illustrating the fuel supply unit of FIG. 3;

FIG. 5 is a cross-sectional view illustrating another embodiment of a fuel supply unit;

FIG. 6 is a cross-sectional view illustrating operation of a fuel cell system according to an embodiment of the present invention;

FIG. 7 is a cross-sectional view illustrating another embodiment of a fuel supply unit;

FIG. 8 is a schematic view illustrating the entire structure of a fuel cell system according to another embodiment of the present invention; and

FIG. 9 is a cross-sectional view illustrating the fuel supply unit shown in FIG. 8.

### DETAILED DESCRIPTION

Hereinafter, exemplary embodiments of the present invention will be described in detail with reference to the accompanying drawings such that the present invention can be easily put into practice by those skilled in the art. However, the present invention may be embodied in various forms and is not limited to the exemplary embodiments described below.

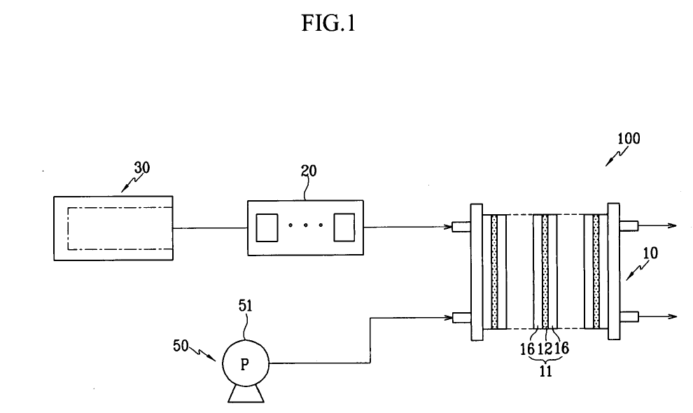

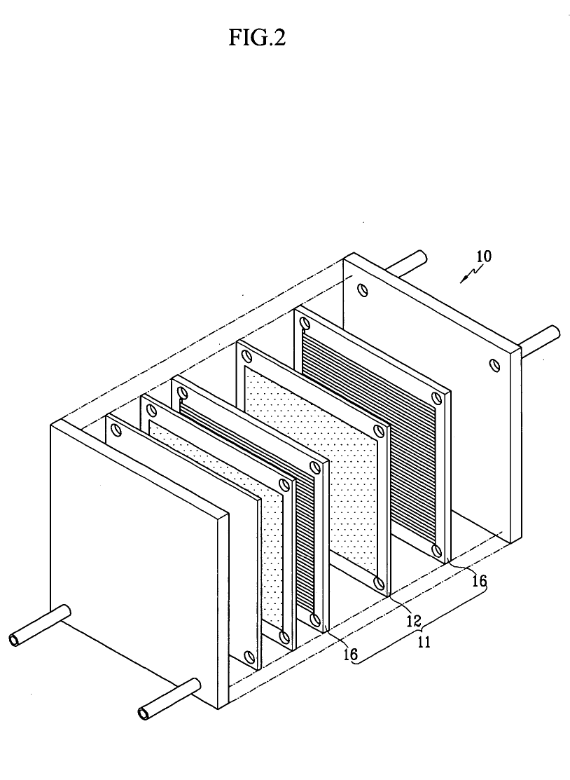

FIG. 1 is a schematic view illustrating the entire structure of a fuel cell system according to a first embodiment of the present invention and FIG. 2 is an exploded perspective view illustrating the stack structure of the fuel cell of FIG. 1.

Referring to the figures, the fuel cell system 100 according to this embodiment of the present invention employs a polymer electrolyte membrane fuel cell (PEMFC) scheme. Hydrogen gas is generated by reforming a fuel containing hydrogen, and electrical energy is generated by reacting the hydrogen gas with oxygen.

The fuel for generating electric energy in the fuel cell system 100 can be any fuel containing hydrogen such as methanol, ethanol, natural gas, etc. For convenience, in the present specification, the term “liquid fuel” is intended to refer to any fuel provided in fluid form, whether a true liquid fuel such as methanol or ethanol, or a gaseous fuel such as natural gas.

In the fuel cell system 100, oxygen may be provided as pure oxygen gas or some other source of oxygen such as air can be used as the source of oxygen. In the following description, air is used as the oxygen source.

The fuel cell system 100 according to the present invention comprises a stack 10 including at least one electricity generator 11 which generates electric energy from an electrochemical reaction between hydrogen and oxygen, a reformer 20 which generates hydrogen gas from a liquid fuel and supplies the hydrogen gas to the electricity generator 11, a fuel supply unit 30 which stores the fuel and supplies the fuel to the reformer 20, and an oxygen source 50 which supplies oxygen to the electricity generator 11 of the stack 10.

Each electricity generator 11 includes a pair of separators 16 adjacent opposing surfaces of a membrane-electrode assembly 12, thereby forming the stack 10 having the stacked structure as shown in the present embodiment. Each membrane-electrode assembly 12 has an anode electrode and a cathode electrode on its opposing surfaces thereof for reacting the hydrogen gas and oxygen in the air using oxidation and reductions reactions. The separators 16 supply the hydrogen gas and air to both sides of the membrane-electrode assembly 12 and connect the anode electrode and the cathode electrode in series.

The oxygen source 50 for supplying oxygen to the electricity generator 11 includes an air compressor 51 which produces air under pressure to the electricity generator 11.

The reformer 20 has, for example, a conventional structure by which hydrogen gas is generated from the fuel through a catalytic reaction. Thermal energy is applied to the reformer and in one embodiment, a hydrogen gas stream is produced with low levels of carbon monoxide. Suitable catalytic reactions used by the reformer 20 include the reformation of water vapor, partial oxidation, natural reaction, etc. The reformer 20 uses a catalytic reaction such as a water gas conversion method, a selective oxidation method, etc. or a method of refining hydrogen using a separating film to reduce the concentration of carbon monoxide contained in the hydrogen gas.

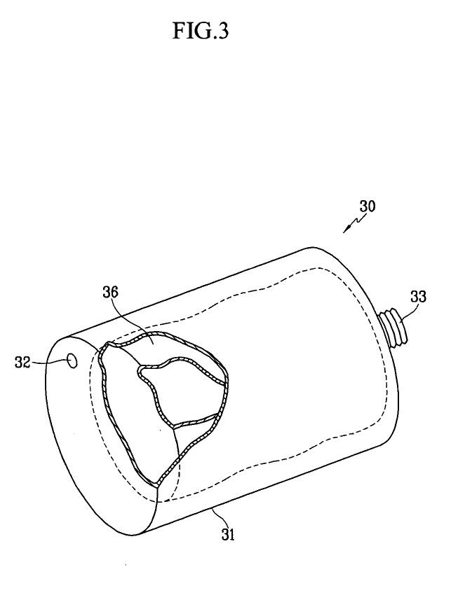

The fuel supply unit 30 according to the present invention which supplies the fuel to the reformer 20 described above will be described in detail with reference to FIGS. 3 to 5.

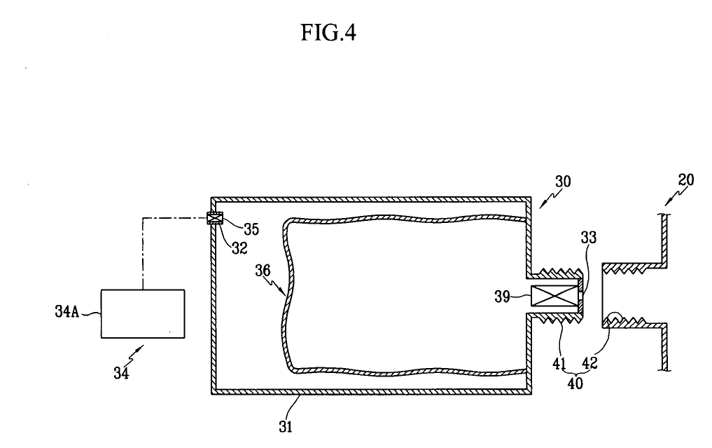

FIG. 3 is a partially cutaway perspective view illustrating a structure of the fuel supply unit shown in FIG. 1, and FIG. 4 is a cross-sectional view illustrating the fuel supply unit shown in FIG. 3.

Referring to the figures, the fuel supply unit 30 according to the present embodiment comprises a cylindrical outer tank 31 connected to the reformer 20, an inner fuel storage tank 36 located in an inner space of the cylindrical outer tank 31 for storing the fuel, and a biasing mechanism 34 connected to the cylindrical outer tank 31 for imparting pressure to the inner fuel storage tank 36.

The cylindrical outer tank 31 is a closed cylindrical vessel which defines an inner space with a predetermined volume. An injection port 32 communicating with the inner space is provided at one end of the cylindrical outer tank 31 and a discharge port 33 is provided in communication with the inner fuel storage tank. The injection port 32 is connected to the biasing mechanism 34 as will be described in more detail below. The discharge port 33 is connected to either the reformer 20 or directly to the stack 10.

The inner fuel storage tank 36 is provided in the inner space of the cylindrical outer tank 31 and defines a fuel storage space in which fuel can be stored. The inner fuel storage tank 36 for this embodiment is made of flexible material so that the fuel storage space can be deformed by the biasing mechanism 34.

The discharge port 33 of the cylindrical outer tank 31 is provided with a static pressure valve 39 which selectively opens and closes the discharge port 33 as the inner fuel storage tank 36 is deformed and the pressure on the fuel within the fuel storage space increases. The static pressure valve 39 is a pressure regulator of a design well known in the art, and comprises a needle valve having a spool for selectively opening and closing the discharge port 33 and a spring elastically biasing the spool toward a center. Therefore, when the internal pressure of the inner fuel storage tank 36 increases up to a predetermined set pressure as pressure is imparted by the biasing mechanism 34, the spool overcomes the elastic force of the spring and thus the static pressure valve 39 opens the discharge port 33 to produce fuel under pressure to the reformer 20. When the internal pressure of the inner fuel storage tank 36 is less than the predetermined set pressure, the spool is elastically biased by the spring and thus the static pressure valve 39 closes the discharge port 33.

The biasing mechanism 34 provides a compressive force to the inner fuel storage tank 36, thereby producing fuel stored in the inner fuel storage tank 36 to the reformer 20 via the discharge port 33 of the cylindrical outer tank 31. according to this embodiment, the biasing mechanism 34 comprises a source of compressed gas such as a compressed air tank 34A.

The compressed air tank 34A is connected to the injection port 32 of the cylindrical outer tank 31 and supplies the compressed gas to the inner space of the cylindrical outer tank 31. Another static pressure valve 35 selectively opens and closes the injection port 32 in accordance with the pressure applied to the inner space of the cylindrical outer tank 31 and is provided between the compressed air tank 34A and the injection port 32 of the cylindrical outer tank 31. The static pressure valve 35 is a pressure regulator of a design well known in the art, and comprises a needle valve having a spool for selectively opening and closing the injection port 32 and a spring elastically biasing the spool toward a center. Therefore, when the pressure of the compressed gas applied to the inner space of the cylindrical outer tank 31 is less than a predetermined set pressure with which the inner fuel storage tank 36 can be compressed to open the injection port 32, the spool overcomes the elastic force of the spring with the pressure of the compressed gas stored in the compressed air tank 34A and thus the static pressure valve 35 opens the injection port 32. When the pressure of the compressed gas within the inner space of the cylindrical outer tank 31 is greater than the predetermined set pressure, the spool is elastically biased by the spring and thus the static pressure valve 35 closes the injection port 32.

While the biasing mechanism has been described as utilizing a source of compressed gas such as a compressed air tank 34A, various other sources of compressed gases or other fluids can be used. As one example, an air compressor can be used to supply compressed air. As another example, a portion of the stream of compressed air from the air compressor 51 that supplies air to the stack can be used. As still other examples, hydraulic fluids such as oil or water can be provided under pressure to the outer tank to provide the necessary pressure to contract the inner fuel tank and produce fuel to either the reformer or the stack. If a hydraulic fluid is used, a hydraulic pump of the type known in the art can be used to impart the necessary pressure to the hydraulic fluid.

In the embodiment of FIG. 4, a threaded coupling 40 connects the discharge port 33 of the cylindrical outer tank 31 to the reformer 20 and is provided between the cylindrical outer tank 31 and the reformer 20. In this embodiment, the threaded coupling 40 has a male threaded portion 42 formed outside the discharge port 33 of the cylindrical outer tank 31 and a mating female threaded portion 41 which is formed in the reformer 20.

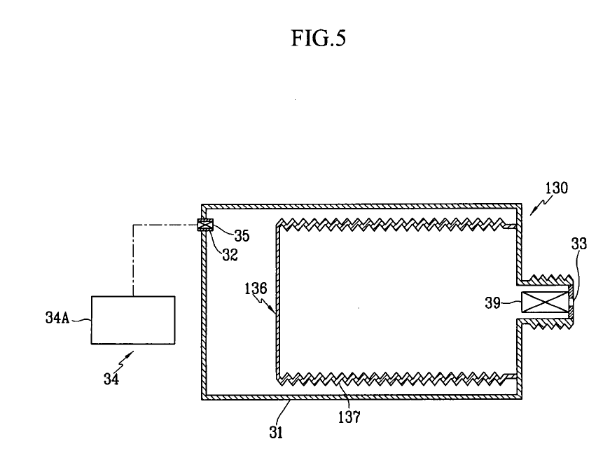

Referring now to FIG. 5, another embodiment of a fuel supply unit 130 is illustrated. According to this embodiment, the cylindrical outer tank 31, the biasing mechanism 34, and other associated elements are as described previously with the difference being the use of an inner fuel storage tank 136 defined by a bellows-shaped wall 137. Such a feature permits the inner fuel storage tank 136 to be selectively contracted and expanded by the biasing mechanism 34.

Next, operation of the fuel cell system according to the first embodiment of the present invention will be described in detail.

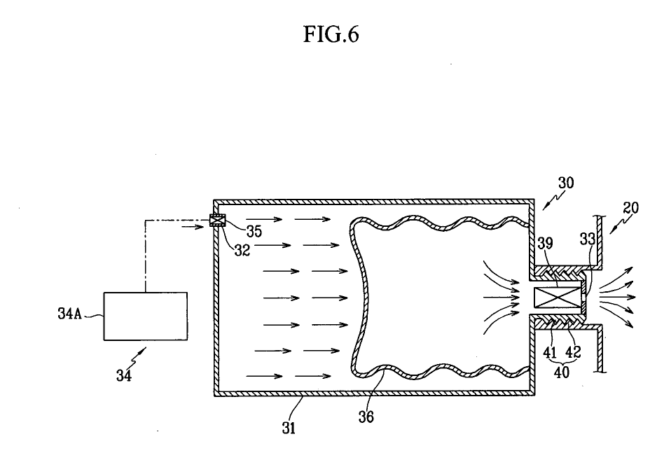

FIG. 6 is a cross-sectional view illustrating the operation of the fuel cell system according to embodiment of FIGS. 3 and 4 of the present invention.

Referring to FIGS. 1 to 4 and 6, the source of compressed gas 34A and the injection port 32 of the cylindrical outer tank 31 are connected to each other and the discharge port 33 of the cylindrical outer tank 31 and the reformer 20 are connected to each other through the threaded coupling 40.

The compressed gas provided by the source of compressed gas 34A is injected into the inner space of the cylindrical outer tank 31 via the injection port 32. As the compressed gas fills the inner space of the cylindrical outer tank 31 and the pressure of the inner space increases, the inner fuel storage tank 36 is deformed and contracts. When the internal pressure of the inner fuel storage tank 36 is greater than the predetermined set pressure of the static pressure valve 39, the discharge port 33 of the outer tank 31 opens.

As the inner fuel storage tank 36 contracts due to the pressure of the compressed gas, the fuel stored in the inner fuel storage tank 36 is pressured from the inner fuel storage tank and is supplied to the reformer 20 via the discharge port 33.

Then, the reformer 20 generates the hydrogen gas from the fuel supplied from the inner fuel storage tank 36 and supplies the hydrogen gas to the electricity generator 11 of the stack 10. In one embodiment, hydrogen is produced by the reformer with a low concentration of carbon monoxide.

Simultaneously, the air compressor 51 is activated and pressurized air is supplied to the electricity generator 11. Therefore, the electricity generator 11 generates electric energy through an electrochemical reaction between the hydrogen gas and oxygen from the air.

In the course of this procedure, when the internal pressure of the inner fuel storage tank 36 is less than the predetermined set pressure, the static pressure valve 39 closes the discharge port 33 of the cylindrical outer tank 31, thereby stopping flow of fuel to the reformer 20 from the inner fuel storage tank 36.

When the pressure of the compressed gas applied to the inner space of the outer tank 31 is less than the predetermined set pressure, the static pressure valve 35 opens the injection port 32 of the outer tank 31, thereby injecting the compressed gas from the source of compressed gas 34A into the inner space of the outer tank 31 via the injection port 32. When the pressure of the compressed gas applied to the inner space of the outer tank 31 is greater than the predetermined set pressure, the static pressure valve 35 closes the injection port 32 of the outer tank 31, thereby stopping the flow of compressed gas into the inner space of the outer tank 31.

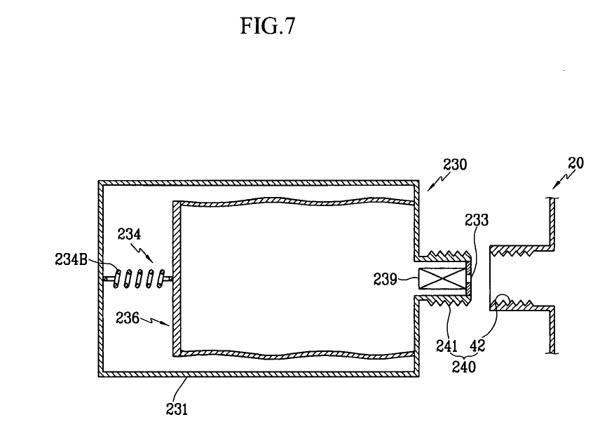

FIG. 7 is a cross-sectional view illustrating another embodiment of the fuel supply unit of the present invention.

Referring to the figure, a fuel supply system 230 is provided having an outer tank 231 and an inner fuel storage tank 236 with flexible side walls 238. The fuel supply system 230 further comprises a biasing mechanism 234 having an elastic member 234B which compresses the inner fuel storage tank 236.

The elastic member 234B is disposed in the inner space of the outer tank 231 and is connected to the inner fuel storage tank 236. In this embodiment, the elastic member 234B comprises a compression spring having a predetermined elastic force. One end of the elastic member 234B is connected to an inner wall of the outer tank 231 and the other end is connected to the body of the inner fuel storage tank 236.

Therefore, by imparting an elastic force from the elastic member 234B to the inner fuel storage tank 236, the inner fuel storage tank 236 is deformed, thereby discharging the fuel stored in the inner fuel storage tank via a static pressure valve 239 through a discharge port 233 of the outer tank 231. A threaded coupling 240 is provided comprising a male threaded portion 241 of the discharge port 233 threaded to a female threaded portion 42 of the reformer 20.

It should be apparent to one of ordinary skill in the art that those biasing mechanisms that rely on a pressurized fluid such as a compressed gas to cause the necessary deformation of the inner fuel storage tank generally require the use of an outer tank that is fluid tight. Similarly, it should also be apparent that those biasing mechanisms that rely on mechanical forces rather than hydraulic or pneumatic forces to cause deformation of the inner fuel storage tank need not be fluid tight.

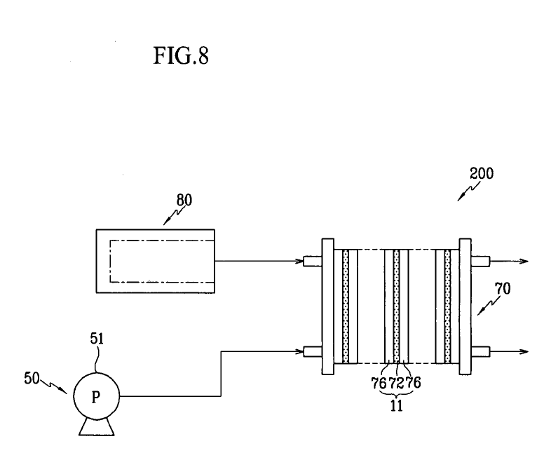

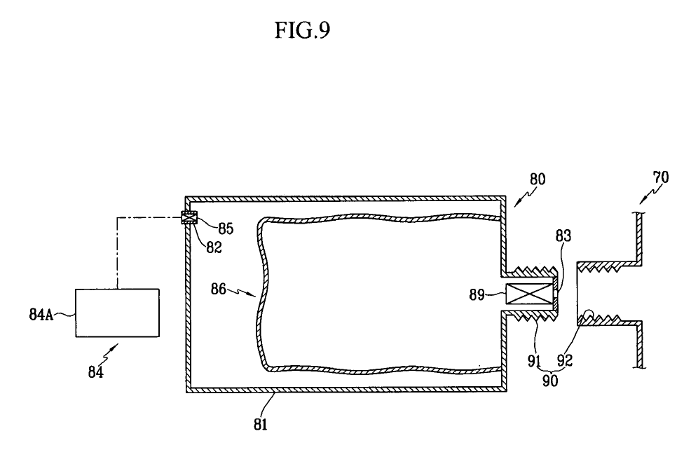

FIG. 8 is a schematic view illustrating the entire structure of the fuel cell system according to another embodiment of the present invention and FIG. 9 is a cross-sectional view illustrating the fuel supply unit shown in FIG. 8.

Referring to the figures, the fuel cell system 200 according to the present embodiment employs a direct methanol fuel cell (DMFC) scheme in which methanol fuel containing hydrogen is directly supplied to a stack 70 and electric energy is generated through electrochemical reaction between hydrogen liberated from the methanol and oxygen. The fuel cell system 200 employing the direct methanol fuel cell scheme does not require the reformer 20 shown in FIG. 1, unlike the fuel cell system according to the first embodiment employing the polymer electrolyte membrane fuel cell scheme.

The fuel cell system 200 comprises a stack 70 having at least one electricity generator 71 which is supplied with methanol fuel containing hydrogen and oxygen and generates electric energy, a fuel supply unit 80 which stores the fuel and supplies the fuel to the electric generator 71 of the stack 70, and an oxygen source 50 which supplies oxygen to the electricity generator 71.

The stack 70 according to the present embodiment generates hydrogen gas from the fuel with a catalytic layer of a membrane-electrode assembly 72 constituting the electricity generator 71 and generates the electric energy through electrochemical reaction between the hydrogen gas and oxygen.

Since the stack 70 has a stack structure employed in a conventional direct methanol fuel cell, detailed description thereof will be omitted. In addition, since the oxygen source 50 has the same structure as that of the previous embodiment, detailed description thereof will be also omitted.

According to the present embodiment, the fuel supply unit 80 comprises a cylindrical outer tank 81 which is connected to the stack 70, an inner fuel storage tank 86 which is provided in the inner space of the outer tank for storing fuel, and a biasing mechanism 84 which is connected to the outer tank 81 and compresses the inner fuel storage tank 86.

The outer tank 81 has a discharge port 83 similar to that of the previous embodiment and is connected to the electricity generator 71 of the stack through a threaded coupling 90. The threaded coupling 90 has a male threaded portion 92 formed outside of the discharge port 83 of the outer tank 81 and a mating female threaded portion 91 which is formed in the stack.

Since the structure of the fuel supply unit 80 according to the present embodiment is similar to the structure of the first embodiment, detailed description thereof will be omitted. In the figures associated with the present embodiment, the biasing mechanism 84 is illustrated as the same source of compressed gas 84A as described previously. However, the present embodiment is not limited to this structure and the biasing mechanism 84 may comprise the elastic member (see 34B of FIG. 7) or various other mechanisms as described above.

As described above, in the fuel cell system according to the present invention, since the fuel can be supplied to the reformer or the stack by compressing the inner fuel storage tank using the biasing mechanism, the parasitic power required for driving the entire system can be reduced, so that it is possible to further improve the energy efficiency of the system.

Further, in the fuel cell system according to the present invention, since a conventional fuel pump can be omitted, it is possible to reduce the size of the entire system.

Furthermore, in the fuel cell system according to the present invention, since the fuel supply unit can be freely attached to or detached from the reformer or the stack through the threaded coupling, installation and replacement thereof is simplified, improving the reliability of the system.

Although embodiments of the present invention have been described in detail hereinabove in connection with certain exemplary embodiments, it will be understood by those skilled in the art that various changes in form and details may be made therein without departing from the spirit and scope of the invention as defined by the appended claims.

1. A fuel supply unit used for a fuel cell system, the fuel cell unit comprising:
an outer tank defining an inner space;
an inner fuel storage tank for storing fuel, the inner fuel storage tank including a deformable wall and located in the inner space of the outer tank; and
a bias mechanism adapted to compress the inner fuel storage tank.

2. The fuel supply unit of claim 1, wherein the inner fuel storage tank has a flexible outer shape.

3. The fuel supply unit of claim 2, wherein the deformable wall of the inner fuel storage tank comprises a bellows-shaped wall.

4. The fuel supply unit of claim 3, wherein the outer tank is cylindrical.

5. The fuel supply unit of claim 1, wherein the bias mechanism comprises a source of compressed gas in communication with the inner space of the outer tank.

6. The fuel supply unit of claim 1, wherein the bias mechanism comprises an elastic member which is provided in the inner space of the cylinder section and connected to the inner fuel storage tank.

7. A fuel cell system comprising:
at least one electricity generator which generates electric energy through electrochemical reaction between hydrogen and oxygen;
a fuel supply unit which supplies fuel containing hydrogen to the electricity generator; and
an oxygen source which supplies oxygen to the at least one electricity generator,
wherein the fuel supply unit comprises: an outer tank defining an inner space; an inner fuel storage tank for storing fuel, the inner fuel storage tank including a deformable wall and located in the inner space of the outer tank;
and a bias mechanism adapted to compress the inner fuel storage tank.

8. The fuel cell system of claim 7, further comprising a plurality of electricity generators arranged in a stack.

9. The fuel cell system of claim 8, wherein the bias mechanism comprises a source of compressed gas in communication with the inner space of the outer tank.

10. The fuel cell system of claim 9, wherein the outer tank comprises an injection port through which compressed gas from the source of compressed gas flows, and a discharge port through which fuel from the inner fuel storage tank is produced to the stack.

11. The fuel cell system of claim 10, wherein the outer tank and the stack are connected by a threaded coupling.

12. The fuel cell system of claim 10, wherein the outer tank comprises a pair of static pressure valves for selectively opening and closing the injection port and the discharge port.

13. The fuel cell system of claim 8, wherein the bias mechanism comprises an elastic member provided in the inner space of the outer tank and connected to the inner fuel storage tank.

14. The fuel cell system of claim 13, wherein the elastic member is a compression spring.

15. The fuel cell system of claim 13, wherein the outer tank comprises a discharge port connected to the stack.

16. The fuel cell system of claim 15, wherein the outer tank and the stack are connected by a threaded coupling.

17. The fuel cell system of claim 16, wherein the outer tank comprises a static pressure valve adapted to selectively open and close the discharge port.

18. The fuel cell system of claim 7, wherein the inner fuel storage tank has a flexible outer shape.

19. The fuel cell system of claim 18, wherein the inner fuel storage tank comprises a bellows-shaped wall.

20. The fuel cell system of claim 19, wherein the outer tank is cylindrical.

21. The fuel cell system of claim 7, wherein the oxygen source comprises an air compressor.

22. The fuel cell system of claim 7, wherein the at least one electricity generator comprises a direct methanol fuel cell (DMFC).

23. A fuel cell system comprising:
at least one electricity generator which generates electric energy through electrochemical reaction between hydrogen and oxygen;
a reformer which generates hydrogen gas from fuel containing hydrogen for the at least one electricity generator;
a fuel supply unit which supplies the fuel to the reformer; and
an oxygen source which supplies oxygen to the electricity generator,
wherein the fuel supply unit comprises: an outer tank defining an inner space; an inner fuel storage tank for storing fuel, the inner fuel storage tank including a deformable wall and located in the inner space of the outer tank; and a bias mechanism adapted to compress the inner fuel storage tank.

24. The fuel cell system of claim 23, wherein the bias mechanism comprises a source of compressed gas in communication with the inner space of the outer tank.

25. The fuel cell system of claim 24, wherein the cylinder section comprises an injection port through which compressed gas from the source of compressed gas flows, and a discharge port through which fuel from the inner fuel storage tank is produced to the reformer.

26. The fuel cell system of claim 25, wherein the outer tank and the reformer are connected by a threaded coupling

27. The fuel cell system of claim 26, wherein the outer tank comprises a pair of static pressure valves for selectively opening and closing the injection port and the discharge port.

28. The fuel cell system of claim 23, wherein the bias mechanism comprises an elastic member provided in the inner space of the outer tank and connected to the inner fuel storage tank.

29. The fuel cell system of claim 28, wherein the elastic member is a compression spring.

30. The fuel cell system of claim 28, wherein the outer tank comprises a discharge port connected to the reformer.

31. The fuel cell system of claim 30, wherein the outer tank and the reformer are connected by a threaded coupling.

32. The fuel cell system of claim 31, wherein the outer tank comprises a static pressure valve adapted to selectively open and close the discharge port.

33. The fuel cell system of claim 23, wherein the inner fuel storage tank has a flexible outer shape.

34. The fuel cell system of claim 33, wherein the inner fuel storage tank comprises a bellows-shaped wall.

35. The fuel cell system of claim 34, wherein the outer tank is cylindrical.

36. The fuel cell system of claim 23, wherein the at least one electricity generator comprises a direct methanol fuel cell (DMFC).
